(19) United States
(12) Patent Application Publication
(10) Pub. No.: US 2007/0067802 A1
(43) Pub. Date: Mar. 22, 2007

(54) Method and apparatus for ordering television stations and programs

(76) Inventors: Michael P. Carlson, Austin, TX (US); Linda A. Lisle, Cedar Park, TX (US); Herman Rodriguez, Austin, TX (US)

Correspondence Address: IBM CORP (YA);C/O YEE & ASSOCIATES PC, P.O. BOX 802333, DALLAS, TX, 75380, US

(21) Appl. No.: 11/232,741

(22) Filed: Sep. 22, 2005

(51) Int. Cl. H04N 5/445; G06F 3/00; G06F 13/00

(52) U.S. Cl. 725/47; 725/44; 725/39

(57) ABSTRACT

A computer implemented method, an apparatus, and computer program product for ordering television stations and programs are provided. Aspects of the present invention allow users to order television stations and programs based on their preferences. In addition, the aspects of the present invention allow the custom order of stations and programs to be displayed contiguously in the programming guide. Furthermore, the aspects of the present invention automatically activate a custom order based on an assignment of a particular time or schedule. Moreover, the aspects of the present invention identify a specific user from a plurality of users that share the same programming guide, such that a corresponding custom order of stations and programs may be retrieved for the specific user.

### BACKGROUND OF THE INVENTION

1. Field of the Invention

The present invention relates generally to a data processing system. In particular, the present invention relates to ordering television stations and programs in a data processing system. Still more particularly, the present invention relates to ordering television stations and programs in a data processing system based on user preferences.

2. Description of the Related Art

Currently, many cable and satellite service providers allow subscribers to view a schedule of current and upcoming television (TV) programs via a programming guide. A programming guide is a listing of television stations and corresponding programs that are available from cable and satellite service providers. In addition, other service providers, such as digital video recording (DVR) service providers, allow users to download and display television programs and schedule the programs to be recorded via the programming guide.

While these service providers provide users quick and easy access to current and future programming schedules, most of the station and program listings are arbitrarily listed or sequentially ordered by number. Thus, when users program the station or program selections, most programming guides allow users to add or delete TV stations or programs only in a sequential order, for example, a station listing ordered from 100 to 200 or a program listing ordered from 10:00 am to 12:00 pm.

If a user has a large number of stations or programs to add or delete, it becomes time-consuming and cumbersome to scroll through all the available stations or programs. While some service providers attempt to find other programs that might be of interest to the users, these service providers fail to allow users to modify or customize the layout of the programming guide. Thus, users may only select from a list of all available stations, rather than from a list of preferred stations that the users are interested in.

### SUMMARY OF THE INVENTION

A computer implemented method, an apparatus, and computer program product for ordering television stations and programs in a programming guide are provided by aspects of the present invention. The aspects of the present invention receive a selection of a subset of television stations and programs from a set of television stations and programs in the programming guide to form a custom order of television stations and programs, store the custom order of television stations and programs, and display the custom order of television stations and programs contiguously in the programming guide.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of the data processing system in which the present invention may be implemented;

FIG. 2 is a block diagram for the major components of a data processing unit in accordance with an illustrative embodiment of the present invention;

FIG. 3 is a block diagram of a data processing system, in accordance with an illustrative embodiment of the present invention may be implemented;

FIG. 4 is a diagram illustrating a known listing of stations and programs in a programming guide;

FIG. 5 is a diagram illustrating an exemplary ordering of stations and programs based on user preferences, in accordance with an illustrative embodiment of the present invention;

FIG. 6 is a flowchart of an exemplary process for ordering of stations and programs based on user preferences, in accordance with an illustrative embodiment of the present invention;

FIG. 7 is a flowchart of an exemplary process for removing stations or programs from the programming guide, in accordance with an illustrative embodiment of the present invention;

FIG. 8 is a flowchart of an exemplary process for activating custom ordering of stations and programs based on a time or schedule, in accordance with an illustrative embodiment of the present invention; and

FIG. 9 is a flowchart of an exemplary process for identifying a specific user from a plurality of user that share the same programming guide, in accordance with an illustrative embodiment of the present invention.

### DETAILED DESCRIPTION OF THE PREFERRED EMBODIMENT

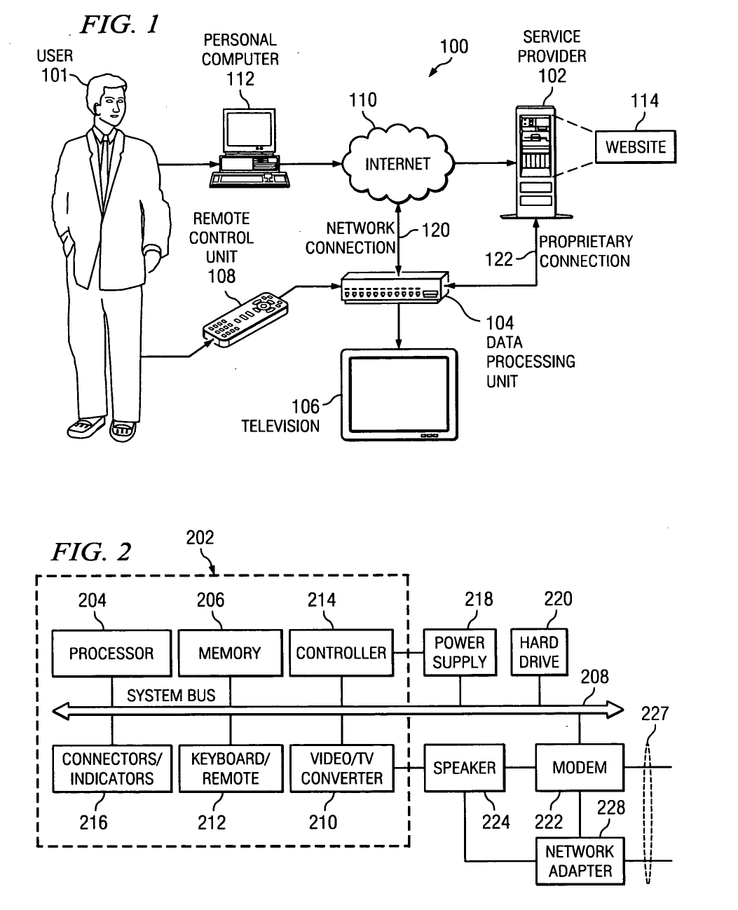

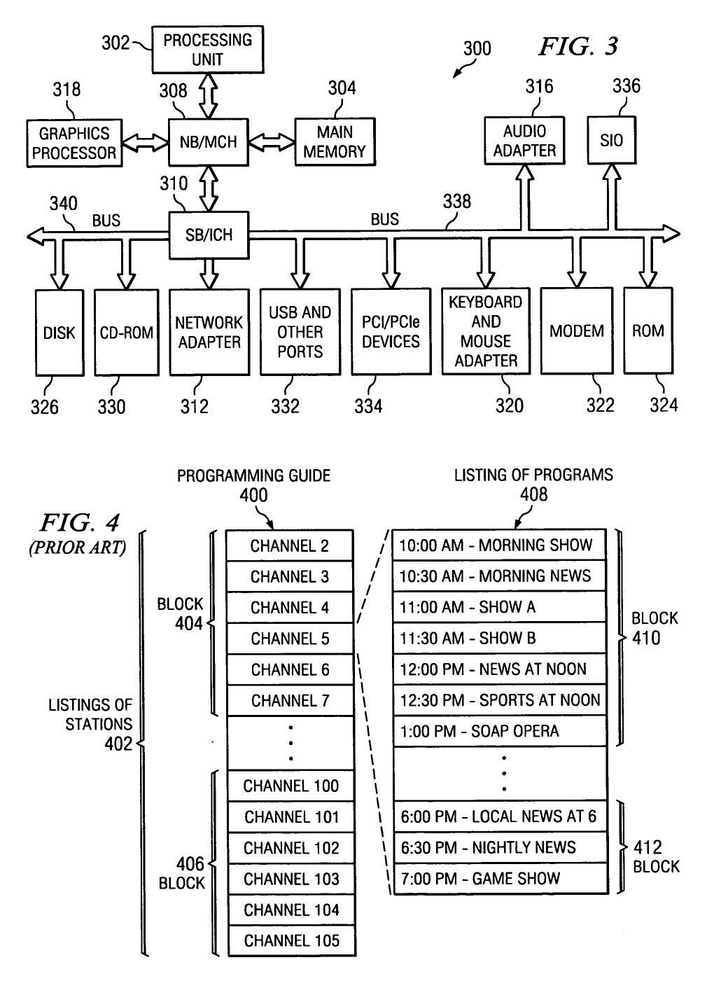

With reference to FIG. 1, a pictorial representation of the data processing system in which aspects of the present invention may be implemented is depicted. Data processing system 100 in the depicted example provides, with minimal economic costs for hardware to user 101, access to service provider 102, for example, cable companies or satellite television providers. Service provider 102 is described in further detail in FIG. 3. User 101 includes a data processing unit 104. Data processing unit 104 is preferably sized to fit in typical entertainment center and provides all required functionalities to enable user 101 to “browse” a programming guide for stations and programs.

Additionally, data processing unit 104 may provide other common entertainment functions such as recording television programs. Examples of data process unit 104 includes a digital video recorder, such as a TiVo Series2 DVR, a product available from TiVo, Inc., and a cable connection box, a product available from cable television providers, such as Time Warner Cable or Comcast Corporation.

Data processing unit 104 is connected to television 106 for display of graphical information, such as a programming guide and other television programs. Television 106 may be any suitable television, although color televisions with a composite or S-Video input will provide better presentations of the graphical information. Data processing unit 104 may be connected to television 106 through a standard coaxial cable connection. Remote control unit 108 allows user 101 to interact with and control data processing unit 104. Remote control unit 108 emits infrared (IR) signals, preferably modulated at a different frequency than the normal television, stereo, and VCR infrared remote control frequencies in order to avoid interference. Remote control unit 108 provides the functionality of a pointing device (such as a mouse, glidepoint, trackball, or the like) in conventional personal computers, including the ability to move a cursor on a display and select items.

In addition to connecting to television 106, data processing unit 104 may also be connected to service provider 102 via Internet 110 using network connection 120 or directly to service provider 102 via proprietary connection 122. Internet 110 is a network representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages.

Network connection 120 may be implemented as an Ethernet connection or a modem connection, while proprietary connection 122 may be implemented as a standard coaxial cable connection or a fiber optics connection.

Furthermore, instead of using remote control unit 108 and data processing unit 104, user 101 may interact with service provider 102 via Website 114 by using personal computer 112. Personal computer 112 is described in further detail in FIG. 3. FIG. 1 is intended as an example, and not as an architectural limitation for different embodiments of the present invention.

As shown in FIG. 2, a block diagram for the major components of data processing unit 104 is depicted in accordance with an illustrative embodiment of the present invention. Data processing unit 104 includes a motherboard 202 containing processor 204 and memory 206 connected to system bus 280 in which computer usable code or instructions implementing the processes for embodiments of the present invention may be located. Memory 206 may include cache memory and/or video RAM. Processor 204, memory 206, and system bus 208 operate in the same manner as corresponding components in a conventional data processing system.

Video/TV converter 210, located on motherboard 202 and connected to system bus 208, generates computer video signals for computer monitors, a composite television signal, and an S-Video signal. The functionality of Video/TV converter 210 may be achieved through a Trident TVG9685 video chip in conjunction with an Analog Devices AD722 converter chip. Video/TV converter 210 may require loading of special operating system device drivers.

Keyboard/remote control interface unit 212 on motherboard 202 receives keyboard codes through controller 214, regardless of whether a wired keyboard/pointing device or an infrared keyboard/remote control is being employed. Infrared remote control unit 108 transmits signals, which are ultimately sent to the serial port as control signals generated by conventional mouse or pointing device movements. Two buttons on remote control unit 108 are interpreted identically to the two buttons on a conventional mouse, while the remainder of the buttons transmits signals corresponding to keystrokes on an infrared keyboard. Thus, remote control unit 108 has a subset of the function provided by an infrared keyboard.

Connectors/indicators 216 on motherboard 202 provide some of the connections and indicators on data processing unit 104. Other connections are associated with and found on other components. Controller 214 controls the power indicator within connectors/indicators 216.

External to motherboard 202 in the depicted example are power supply 218, hard drive 220, modem 222, network adapter 228, and speaker 224. Power supply 218 is a conventional power supply except that it receives a control signal from controller 214 which effects shut down of all power to motherboard 202, hard drive 220, and modem 222. In some recovery situations, removing power and rebooting is the only guaranteed method of resetting all of these devices to a known state. Thus, power supply 218, in response to a signal from controller 214, is capable of powering down and restarting data processing unit 104.

Controller 214 is preferably one or more of the 805x family controllers. Controller 214 receives and processes input from infrared remote control 108, infrared keyboard, wired keyboard, or wired mouse. When one keyboard or pointing device is used, all others are locked out (ignored) until none have been active for a prescribed period of time. Then the first keyboard or pointing device to generate activity locks out all others. As part of the failure recovery system, controller 214 specifies the boot sector selection during any power off-on cycle.

Hard drive 220 contains application software for data processing unit 104, which preferably includes an operating system such as Windows® XP, a product of Microsoft Corporation in Redmond, Wash.; and Netscape Navigator, a product of Netscape Communications Corporation in Mountain View, Calif. In addition, hard drive 220 may contain other software applications that are necessary for communicating with a service provider, recording programs, operating a programming guide, as well as storage for other entertainment information.

Hard drive 220 also supports a conventional file transfer protocol (FTP) mechanism to facilitate file transfers from Internet FTP sites, all in a known manner. Other conventional Internet tools, including e-mail, bulletin board, and on-line chat capability, may also be provided. Of course, the software identified above is merely representative, as other known programs may be used in the alternative or by way of addition. Also, minor modifications of these software packages may be desirable to optimize performance of data processing unit 104.

Modem 222 may be any suitable modem used in conventional data processing systems, but is preferably a 33.6 kbps modem supporting the V.42bis, V.34, V.17 Fax, MNP 1-5, and AT command sets. To maintain the slim height of data processing system 104, modem 222 is preferably inserted into a slot mounted sideways on motherboard 202. Modem 222 is connected to a physical communication link 227, which, in turn, is connected or connectable to the Internet, such as Internet 110 in FIG. 1. Alternative, instead of using modem 222 to communication to the Internet, network adapter 228, may be inserted into a slot on motherboard 202 to connect to physical communication link 227, which is connected or connectable to the Internet, such as Internet 110 in FIG. 1.

Those skilled in the art will recognize that the components depicted in FIGS. 1 and 2 and described above may be varied for specific applications or embodiments. Such variations in which the present invention may be implemented are considered to be within the spirit and scope of the present invention.

With reference now to FIG. 3, a block diagram of a data processing system is shown in which aspects of the present invention may be implemented. Data processing system 300 is an example of a computer, such as personal computer 112 in FIG. 1, or a server, such as service provider 102 in FIG. 1, in which computer usable code or instructions implementing the processes for embodiments of the present invention may be located.

In the depicted example, data processing system 300 employs a hub architecture including north bridge and memory controller hub (NB/MCH) 308 and south bridge and input/output (I/O) controller hub (SB/ICH) 310. Processing unit 302, main memory 304, and graphics processor 318 are connected to NB/MCH 308. Graphics processor 318 may be connected to NB/MCH 308 through an accelerated graphics port (AGP).

In the depicted example, local area network (LAN) adapter 312, audio adapter 316, keyboard and mouse adapter 320, modem 322, read only memory (ROM) 324, hard disk drive (HDD) 326, CD-ROM drive 330, universal serial bus (USB) ports and other communication ports 332, and PCI/PCIe devices 334 connect to SB/ICH 310 through bus 338. PCI/PCIe devices may include, for example, Ethernet adapters, add-in cards, and PC cards for notebook computers. PCI uses a card bus controller, while PCIe does not. ROM 324 may be, for example, a flash binary input/output system (BIOS). HDD 326 and CD-ROM drive 330 connect to SB/ICH 310 through bus 340. HDD 326 and CD-ROM drive 330 may use, for example, an integrated drive electronics (IDE) or serial advanced technology attachment (SATA) interface. Super I/O (SIO) device 336 may be connected to SB/ICH 310.

An operating system runs on processing unit 302 and coordinates and provides control of various components within data processing system 300 in FIG. 3. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 300 (Java is a trademark of Sun Microsystems, Inc. in the United States, other countries, or both).

As a server, data processing system 300 may be, for example, an IBM® eServer™ pSeries® computer system, running the Advanced Interactive Executive (AIX®) operating system or the LINUX operating system (eServer, pSeries and AIX are trademarks of International Business Machines Corporation in the United States, other countries, or both while LINUX is a trademark of Linus Torvalds in the United States, other countries, or both). Data processing system 300 may be a symmetric multiprocessor (SMP) system including a plurality of processors in processing unit 302. Alternatively, a single processor system may be employed.

Instructions for the operating system, the object-oriented programming system, and applications or programs are located on storage devices, such as HDD 326, and may be loaded into main memory 304 for execution by processing unit 302. The processes for embodiments of the present invention are performed by processing unit 302 using computer usable program code, which may be located in a memory such as, for example, main memory 304, ROM 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

As some illustrative examples, data processing system 300 may be a personal digital assistant (PDA), which is configured with flash memory to provide non-volatile memory for storing operating system files and/or user-generated data.

A bus system may be comprised of one or more buses, such as bus 338 or bus 340 as shown in FIG. 3. Of course the bus system may be implemented using any type of communications fabric or architecture that provides for a transfer of data between different components or devices attached to the fabric or architecture. A communications unit may include one or more devices used to transmit and receive data, such as modem 322 or network adapter 312 of FIG. 3. A memory may be, for example, main memory 304, ROM 324, or a cache such as found in NB/MCH 308 in FIG. 3. The depicted examples in FIG. 3 and above-described examples are not meant to imply architectural limitations. For example, data processing system 300 also may be a tablet computer, laptop computer, or telephone device in addition to taking the form of a PDA.

Current programming guides fail to provide the ability to order stations based on a particular time or schedule. For example, a user may wish to select a number of stations to watch during the day and a different number of stations to watch in the evening. In addition, current service providers fail to distinguish ordering of television stations or programs between different users that view or use the same programming guide. For example, when user A selects a different listing of stations and programs than user B, current service providers fail to identify a selected order for each user. The aspects of the present invention recognizes the above shortcomings and provides an improved method that allow users to order or group television stations and programs based on user preferences. In one aspect of the present invention, users may select a subset of television stations or programs from a list of stations or programs to form a custom order. Users may select more than one subset of television stations or programs based on their need. The users may select a subset of television stations or programs using a remote control unit, such as remote control unit 108 for data processing unit 104 in FIG. 1.

The custom order may be contiguously displayed at the top of a main page of the programming guide. The programming guide is displayed on a television, such as television 106 in FIG. 1. The custom order may also be removed from the list of stations or programs or remain displayed in their predefined order in the programming guide. In this way, users need not scroll through the whole list of stations to find stations or programs that are of interest to them. In addition, as the number of stations or programs increases, users may view their preferred station or program listings more quickly and easily.

Alternatively, instead of using a remote control unit to select a subset of television stations or programs, users may log onto a Website provided by the service provider using a personal computer and select a subset of television stations or programs to form a custom order. For example, the user may select a subset of stations and programs via Website 114 using personal computer 112 as shown in FIG. 1. By selecting the subset via a service provider Website, users may order the stations or programs based on their preferences at a location other than their homes, for example, their offices, and view the same custom order at home.

Once a subset of television stations or programs is selected to form a custom order, another aspect of the present invention allows users to automatically activate the custom order based on a particular time or schedule. The particular time or schedule may also be selected by using a remote control unit, such as remote control unit 108 and data processing unit 104 in FIG. 1, or via a service provider Website using a personal computer, such as via Website 114 using personal computer 112 in FIG. 1. For example, a user may select one custom station or program order for weekends and a different custom station or program order for the weekdays. In this way, users may quickly and easily select a station or program order for different time or schedule to view or record programs.

In addition to selecting a custom order and activating the custom order based on a time or schedule, another aspect of the present invention distinguishes ordering of television stations and programs between different users that view or use the same television or programming guide. The aspect of the present invention identifies a specific user from a plurality of users that share the same television or programming guide based on common security features, such as a user name and password combination. This aspect of the present invention may be implemented in a data processing unit, such as data processing unit 104 in FIG. 1, or in a service provider Website, such as Website 114 in FIG. 1.

Upon identifying the specific user, the aspect of the present invention displays or activates a custom order of stations or programs that corresponds to the specific user. In this way, access to stations and programs may be restricted based on a user preference. For example, a parent may setup a custom ordering of programs that is suitable for a young child and assigns a user name and password combination to the custom ordering. With the aspects of the present invention, the young child may only view or activate an ordering of programs that correspond to his or her identity.

In order to implement custom ordering of programs and stations, the aspects of the present invention modify the software or other programming mechanisms currently in data processing units, such as data processing unit 104 in FIG. 1; televisions, such as television 106 in FIG. 1; or service provider Websites, such as Website 114 in FIG. 1, to store user station or program order preferences and displays in the programming guide the preferred order. In addition, aspects of the present invention modify software currently in data processing units, televisions, and service provider Websites to select and activate a custom station order at a given time or schedule. Furthermore, aspects of the present invention modify software currently in data processing units, televisions, and service provider Websites to identify a specific user from a plurality of users that share the same television or programming guide.

In one aspect, the modification of the software in televisions and programming guides may be implemented locally by modifying the local mapping in data processing units and televisions. The local mapping may be stored in a hard drive, such as hard drive 220 in motherboard 202 of data processing unit 104. The local mapping may be modified to include a mapping of users and corresponding ordering of stations and programs selected by the users. For example, user A may select channels 2, 6, and 10 as a custom order. The local mapping is thus modified to include a mapping of user A with an order of channels 2, 6, and 10. When a user requests for a list of channels in the programming guide, the local mapping is used to display or activate the custom order of channels.

In another aspect, instead of modifying the local mapping, the software in data processing units and televisions may be modified to upload the custom order to the service provider at a remote location, such that the service provider may store the information and download the custom order of television stations or programs to the television or the data processing unit at a given time or schedule specified by the users. The modified software may be embodied in the application software stored in a hard drive, such as hard drive 220 in motherboard 202 of data processing unit 104 in FIG. 1.

For example, when user A selects a custom order of channels, the television or the programming guide is programmed to upload the custom order to the service provider. When a user-specified schedule or time arrives, the service provider downloads the custom order of channels to the television or programming guide, which is programmed to display or activate the custom order of channels when the custom order is received. In one aspect, the custom order may be uploaded to or downloaded from the service provider using proprietary connection, such as a standard coaxial cable connection or a fiber optics connection, or common multimedia communication connections, such as a network connection.

In this way, the custom ordering of stations and programs may be stored in a remote location, which may later be downloaded to the television or programming guide to be activated or displayed. Alternatively, the service provider may download the custom order to other users that also share the same custom order using a different television or programming guide. Furthermore, with the ability to download the custom ordering of stations and programs at a given time or schedule, the service provider may enforce restriction of access to the custom order as specified by the users by requesting a user name and password at the time the custom order is downloaded. In this way, a specific user from a plurality of users that share the same television or programming guide may be identified.

Turning now to FIG. 4, a diagram illustrating a known listing of stations and programs in a programming guide is depicted. As shown in FIG. 4, programming guide 400 is listing of stations 402 that may be embodied in data processing units, such as data processing unit 104, or televisions, such as television 106 in FIG. 1. Within listing of stations 402, stations are ordered sequentially by number and are displayed in programming guide 400 by blocks. In this example, channels 2-7 are displayed as block 404 in the programming guide. Similarly, channels 100-105 are displayed as block 406 in the programming guide. With listing of stations 402 ordered by number, users have to scroll through the whole listing of stations 402 in order to find stations that may be of interest to them.

In addition to listing of stations 402, programming guide 400 includes a listing of programs for each station. In this example, listing of programs 408 for channel 5 is displayed in programming guide 400. Similar to listing of stations 402, listing of programs 408 is sequentially ordered by blocks of time. In this example, programs between 10:00 am and 1:00 pm are displayed as block 410 in the programming guide. Similarly, programs between 6:00 pm and 7:00 pm are displayed as block 412 in the programming guide. With listing of stations 402 ordered by time, users have to scroll through the whole list of programs 408 in order to find programs that may be of interest to them.

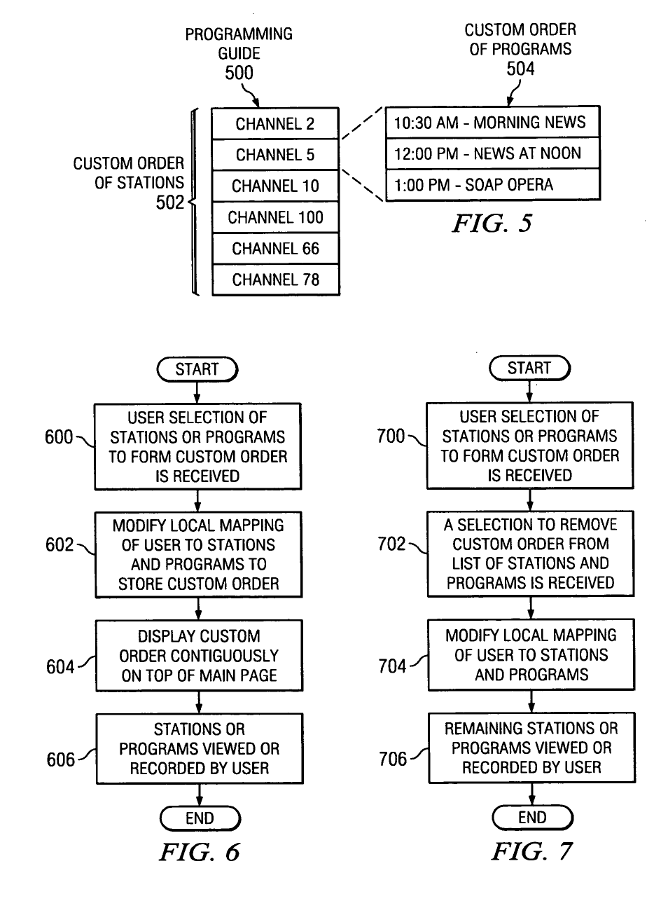

The aspects of the present invention alleviate the above shortcomings by allowing users to order stations and programs based on their preferences. Turning now to FIG. 5, a diagram illustrating an exemplary ordering of stations and programs based on user preferences is depicted in accordance with an illustrative embodiment of the present invention. As shown in FIG. 5, with aspects of the present invention, a user may select a subset of stations from a listing of stations, such as listing of stations 402 in FIG. 4 to form a custom order of stations 502. In this example, the user selects channels from different blocks of numbers, including channels 2, 5, 10, 100, 66, and 78 to form custom order of stations 502. Custom order of stations 502 may be displayed contiguously at the top of a main page in programming guide 500. Alternatively, the user may remove custom order of stations 502 from listing of stations 402 in FIG. 4.

In addition, with aspects of the present invention, the user may select a subset of programs from a listing of programs for each station, such as listing of programs 408 in FIG. 4. In this example, the user selects programs from different blocks of time for channel 5, including programs at 10:30 am, 12:00 pm, and 1:00 pm, to form custom order of programs 504. Custom order of stations 502 may also be displayed at the top of a main page in programming guide 500 next to custom order of stations 502 or removed from listing of programs 408 in FIG. 4.

By allowing users to select a custom ordering of stations and programs, users are no longer required to scroll through a whole listing of stations and programs in order to find their favorite stations and programs. In addition, by ordering stations and programs based on user preferences, the users may easily and quickly access their favorite stations and programs in order to view or record programs.

Turning now to FIG. 6, a flowchart of an exemplary process for ordering of stations and programs based on user preferences is depicted in accordance with an illustrative embodiment of the present invention. This exemplary process may be implemented by modifying the software in televisions, data processing units, or service provider Websites. For example, the exemplary process may be implemented by modifying the software in television 106, data processing unit 104 or service provider Website 114 in FIG. 1. From the perspective of a television, a data processing unit, or a service provider Website, the process begins when a user selection of a subset of stations or programs from a list of stations and programs in the programming guide to form a custom order of stations or programs is received (step 600). Next, the process modifies the local mapping of the user to corresponding stations and programs to store the custom order (step 602). Alternatively, the custom order of stations or programs may be selected by the user via a service provider Website using a personal computer. In this case, rather than modifying the local mapping, the custom order is stored in the service provider Website.

Once the custom order is stored, in one embodiment, the custom order is displayed on top of the main page of the programming guide (step 604). In turn, the programs may be viewed or recorded using the custom order (step 606). Thus, the process terminates thereafter.

Turning now to FIG. 7, a flowchart of an exemplary process for removing stations or programs from the programming guide is depicted in accordance with an illustrative embodiment of the present invention. This exemplary process may be implemented by modifying the software in televisions, data processing units or service provider Websites. For example, the exemplary process may be implemented by modifying the software in television 106, data processing unit 104 or service provider Website 114 in FIG. 1. From the perspective of a television, a data processing unit, or a service provider Website, the process begins when a user selection of a subset of stations or programs from a list of stations and programs in the programming guide is received to form a custom order of stations or programs (step 700). Alternatively, a custom order that is previously stored in the data processing unit, television, or a service provider Website may be retrieved by the user.

A selection to remove the custom order of stations and programs from the list of stations and programs in the programming guide is received from the user (step 702). Next, the process modifies the local mapping of the user and corresponding stations and programs to remove the custom order (step 704). Alternatively, if the custom order is previously stored in the service provider Website, the custom order is removed. Once the custom order is removed, in one embodiment, remaining stations and programs in the list of stations and programs in the programming guide may be viewed or recorded by the user (step 706). Thus, the process terminates thereafter.

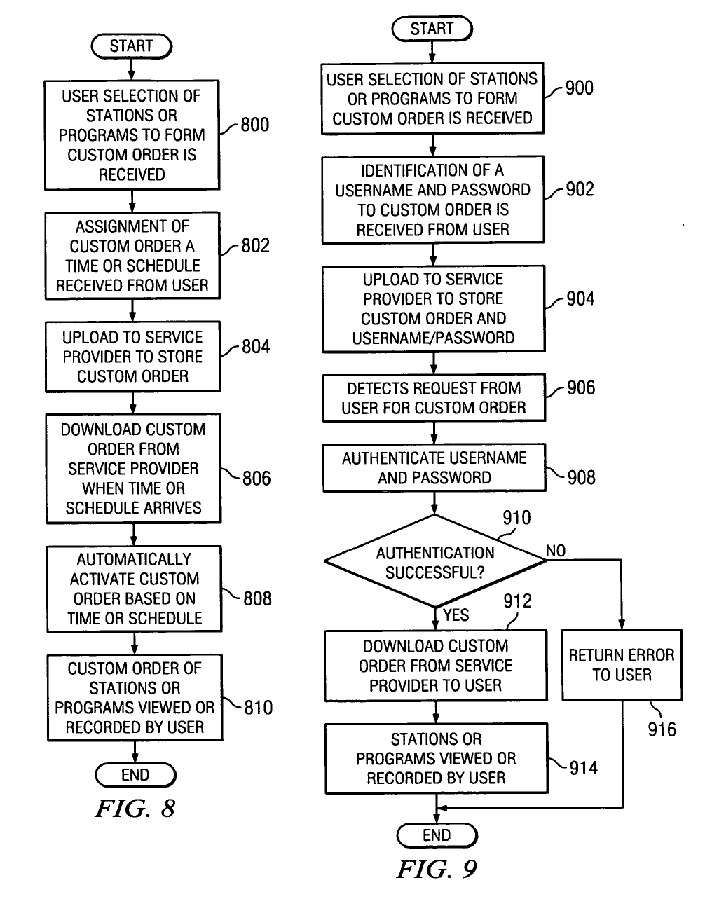

Turning now to FIG. 8, a flowchart of an exemplary process for activating a custom ordering of stations and programs based on a time or schedule is depicted in accordance with an illustrative embodiments of the present invention. This exemplary process may be implemented by modifying the software in televisions, data processing units, or service provider Websites. For example, the exemplary process may be implemented by modifying the software in television 106, data processing unit 104 or service provider Website 114 in FIG. 1. From the perspective of a television, a data processing unit, or a service provider Website, the process begins when a user selection of a subset of stations or programs from a list of stations and programs in the programming guide to form a custom order of stations or programs is received (step 800). Next, an assignment of particular time or schedule to activate the custom order is also received from the user (step 802). An example of a particular schedule includes weekends, weeknights, mornings, afternoons, evenings, every two weeks, and the like. The custom order and a particular time or schedule maybe selected and assigned by the user via a service provider Website using a personal computer.

In one embodiment, the process uploads the custom order to the service provider to store the custom order (step 804). When the selected time or schedule arrives, the custom order of stations and programs is downloaded from the service provider (step 806). The custom order of stations and programs may be downloaded from the service provider via a proprietary connection or a network connection. Upon receiving the custom order from the service provider, the process automatically activates the custom order based on the selected time or schedule (step 808). Once the custom order is activated, in one embodiment, programs may be viewed or recorded by the user using the custom order (step 810). Thus, the process terminates thereafter.

Turning now to FIG. 9, a flowchart of an exemplary process for identifying a specific user from a plurality of user that share the same programming guide is depicted in accordance with an illustrative embodiment of the present invention. This exemplary process may be implemented by modifying the software in televisions, data processing units, or service provider Websites. For example, the exemplary process may be implemented by modifying the software in television 106, data processing unit 104 or service provider Website 114 in FIG. 1. From the perspective of a television, a data processing unit, or a service provider Website, the process begins when a user selection of a subset of stations or programs from a list of stations and programs in the programming guide to form a custom order of stations or programs is received (step 900). Next, an identification of a username and password for the custom order is received from the user (step 902). The selection of the custom order of stations and programs and the identification of the username and password may be selected by the user via a service provider Website using a personal computer or using a remote control unit and a data processing unit.

In one embodiment, the process uploads the custom order to the service provider to store the custom order and the username and password combination (step 904). Later, upon detecting a request from the user for a custom order (step 906), the process authenticates the username and password supplied by the user (step 908). The username and password may be authenticated via a proprietary connection or a network connection. The service provider makes a determination as to whether the authentication is successful (step 910). If the authentication is successful, the custom order of stations programs is downloaded from the service provider (step 912) and the programs may be viewed or recorded using the custom order (step 914). Thus, the process terminates thereafter.

Turning back to step 910, if the authentication is unsuccessful, an error is returned to the user (step 916) and the process terminates thereafter. The error may be returned via a proprietary connection or a network connection. Rather than storing the custom order remotely, the process may modify the local mapping of the data processing unit to store the custom order. In this case, when the user requests for the custom order, the process authenticates the username and password supplied by the user before displaying the custom order at the top of the main page in the programming guide. The programs may then be viewed or recorded by the user using the custom order.

In summary, the aspects of the present invention provide a way to order television stations and programs based on user preferences. In addition, the aspects of the present invention allow the custom order of stations and programs to be displayed contiguously in the programming guide. Furthermore, the aspects of the present invention automatically activate a custom order based on a particular time or schedule. Moreover, the aspects of the present invention identify a specific user from a plurality of users that share the same programming guide, such that a corresponding custom order may be retrieved for the specific user. With the aspects of the present invention, users may manage stations and programs more quickly and easily without the need to scroll through a whole list of stations and programs.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), and digital video disc (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for ordering television stations and programs in a programming guide, the computer implemented method comprising:
receiving a selection of a subset of television stations and programs from a set of television stations and programs in the programming guide to form a custom order of television stations and programs;
storing the custom order of television stations and programs; and
displaying the custom order of television stations and programs contiguously in the programming guide.

2. The computer implemented method of claim 1, further comprising:
removing television stations and programs in the custom order from the set of televisions stations and programs in the programming guide.

3. The computer implemented method of claim 1, further comprising:
assigning the custom order of television stations and programs with at least one of a time and a schedule; and
automatically activating the custom order of television stations and programs in the programming guide based on assignment of the at least one of the time and the schedule with the custom order of television stations and programs.

4. The computer implemented method of claim 3, wherein the schedule is selected from one of a weekend, a weeknight, a morning, an afternoon, an evening, and a time interval.

5. The computer implemented method of claim 1, wherein the receiving and storing steps comprise:
receiving the selection of the subset of television stations and programs via a service provider Website using a personal computer; and
storing the custom order of television stations and programs in the service provider Website.

6. The computer implemented method of claim 1, wherein the storing step comprises:
modifying a local mapping to store the custom order of television stations and programs, wherein the local mapping is a mapping of users to corresponding ordering of stations and programs.

7. The computer implemented method of claim 1, further comprising:
assigning the custom order of television stations and programs with a user name and password for a specific user in a plurality of users sharing the programming guide;
responsive to a user request for the custom order of television stations and programs, authenticating the user request based on the user name and password; and
downloading the custom order of television stations and programs to the specific user if authentication is successful.

8. A data processing system for ordering of television stations and programs in a programming guide, the data processing system comprising:
a bus,
a storage device, wherein the storage device contains computer usable code;
a communications unit connected to the bus; and
a processing unit connected to the bus, wherein the processing unit executes the computer usable code to receive a selection of a subset of television stations and programs from a set of television stations and programs in the programming guide to form a custom order of television stations and programs; store the custom order of television stations and programs; and display the custom order of television stations and programs contiguously in the programming guide.

9. The data processing system of claim 9, wherein the processing unit further executes the computer usable code to remove television stations and programs in the custom order from the set of televisions stations and programs in the programming guide.

10. The data processing system of claim 9, wherein the processing unit further executes the computer usable code to assign the custom order of television stations and programs with at least one of a time and a schedule; and automatically activate the custom order of television stations and programs in the programming guide based on assignment of the at least one of the time and the schedule with the custom order of television stations and programs.

11. The data processing system of claim 9, wherein the processing unit, in executing the computer usable code to receive a selection of a subset of television stations and programs from a set of television stations and programs in the programming guide to form a custom order of television stations and programs and store the custom order of television stations and programs, executes the computer usable code to receive a selection of the subset of television stations and programs via a service provider Website using a personal computer; and store the custom order of television stations and programs in the service provider Website.

12. The data processing system of claim 9, wherein the processing unit, in executing the computer usable code to store the custom order of television stations and programs, executes the computer usable code to modify a local mapping to store the custom order of television stations and programs, wherein the local mapping is a mapping of users to corresponding ordering of stations and programs.

13. The data processing system of claim 9, wherein the processing unit further executes the computer usable program code to assign the custom order of television stations and programs with a user name and password for a specific user in a plurality of users sharing the programming guide; authenticate the user request based on the user name and password responsive to a user request for the custom order of television stations and programs; and download the custom order of television stations and programs to the specific user if authentication is successful.

14. A computer program product comprising:
a computer usable medium having computer usable program code for ordering television stations and programs in a programming guide, said computer program product including:
computer usable program code for receiving a selection of a subset of television stations and programs from a set of television stations and programs in the programming guide to form a custom order of television stations and programs;
computer usable program code for storing the custom order of television stations and programs; and
computer usable program code for displaying the custom order of television stations and programs contiguously in the programming guide.

15. The computer program product of claim 14, further comprising:
computer usable program code for removing television stations and programs in the custom order from the set of televisions stations and programs in the programming guide.

16. The computer program product of claim 15, further comprising:
computer usable program code for assigning the custom order of television stations and programs with at least one of a time and a schedule; and
computer usable program code for automatically activating the custom order of television stations and programs in the programming guide based on assignment of the at least one of the time and the schedule with the custom order of television stations and programs.

17. The computer program product of claim 15, wherein the computer usable program code for receiving a selection a subset of television stations and programs from a set of television stations and programs in the programming guide to form a custom order of television stations and programs and storing the custom order of television stations and programs comprises:
computer usable program code for receiving a selection of the subset of television stations and programs via a service provider Website using a personal computer; and
computer usable program code for storing the custom order of television stations and programs in the service provider Website.

18. The computer program product of claim 15, wherein the computer usable program code for storing the custom order of television stations and programs comprises:
computer usable program code for modifying a local mapping to store the custom order of television stations and programs, wherein the local mapping is a mapping of users to corresponding ordering of stations and programs.

19. The computer program product of claim 15, further comprising:
computer usable program code for assigning the custom order of television stations and programs with a user name and password for a specific user in a plurality of users sharing the programming guide;
computer usable program code for authenticating the user request based on the user name and password responsive to a user request for the custom order of television stations and programs; and
computer usable program code for downloading the custom order of television stations and programs to the specific user if authentication is successful.

20. The computer program product of claim 16, wherein the schedule is selected from one of a weekend, a weeknight, a morning, an afternoon, an evening, and a time interval.
